(19) United States
(12) Patent Application Publication
(10) Pub. No.: US 2026/0057283 A1
(43) Pub. Date: Feb. 26, 2026

(54) CONFORMAL PREDICTION DRIVEN ADAPTIVE PARALLELISM CONTROLLER FOR ENHANCED SELECTIVE STATE SPACE MODEL EFFICIENCY

(71) Applicant: Dell Products L.P., Round Rock, TX (US)

(72) Inventors: Kailash Talreja, Mumbal (IN); Saurabh Jha, Leander, TX (US)

(21) Appl. No.: 18/809,518

(22) Filed: Aug. 20, 2024

(51) Int. Cl. G06N 20/00

(52) U.S. Cl. CPC G06N 20/00

(57) ABSTRACT

A method for prediction refinement. The method includes: for each training domain-task prediction in a training domain-task prediction sequence: computing a training non-conformity score based on a domain-task target and the training domain-task prediction; computing a training probability (p)-value based on the training non-conformity score and a calibrating non-conformity score sequence; computing a training confidence interval based on the training p-value; computing a training confidence measure based on the training confidence interval; computing a training resource allocation based on the training confidence measure; selecting a training parallelism strategy based on the training resource allocation and at least one task characteristic; and processing, given the training resource allocation and in accordance with the training parallelism strategy, a domain-task input sequence segment to produce a refined training domain-task prediction.

### BACKGROUND

Selective State Space Models (SSMs) are pivotal in the realm of artificial intelligence and machine learning for handling sequential data, yet they encounter significant challenges, particularly in computational efficiency and predictive reliability. These challenges are more pronounced when dealing with large-scale datasets or highly complex sequences.

### SUMMARY

In general, in one aspect, embodiments described herein relate to a method for prediction refinement. The method includes: for each training domain-task prediction in a training domain-task prediction sequence: computing a training non-conformity score based on a domain-task target and the training domain-task prediction; computing a training probability (p)-value based on the training non-conformity score and a calibrating non-conformity score sequence; computing a training confidence interval based on the training p-value; computing a training confidence measure based on the training confidence interval; computing a training resource allocation based on the training confidence measure; selecting a training parallelism strategy based on the training resource allocation and at least one task characteristic; and processing, given the training resource allocation and in accordance with the training parallelism strategy, a domain-task input sequence segment to produce a refined training domain-task prediction.

In general, in one aspect, embodiments described herein relate to a non-transitory computer readable medium (CRM). The non-transitory CRM includes computer readable program code, which when executed by a computer processor, enables the computer processor to perform a method for prediction refinement. The method includes: for each training domain-task prediction in a training domain-task prediction sequence: computing a training non-conformity score based on a domain-task target and the training domain-task prediction; computing a training probability (p)-value based on the training non-conformity score and a calibrating non-conformity score sequence; computing a training confidence interval based on the training p-value; computing a training confidence measure based on the training confidence interval; computing a training resource allocation based on the training confidence measure; selecting a training parallelism strategy based on the training resource allocation and at least one task characteristic; and processing, given the training resource allocation and in accordance with the training parallelism strategy, a domain-task input sequence segment to produce a refined training domain-task prediction.

In general, in one aspect, embodiments described herein relate to a model efficiency optimizer. The model efficiency optimizer includes: a computer processor configured to perform a method for prediction refinement. The method includes: for each training domain-task prediction in a training domain-task prediction sequence: computing a training non-conformity score based on a domain-task target and the training domain-task prediction; computing a training probability (p)-value based on the training non-conformity score and a calibrating non-conformity score sequence; computing a training confidence interval based on the training p-value; computing a training confidence measure based on the training confidence interval; computing a training resource allocation based on the training confidence measure; selecting a training parallelism strategy based on the training resource allocation and at least one task characteristic; and processing, given the training resource allocation and in accordance with the training parallelism strategy, a domain-task input sequence segment to produce a refined training domain-task prediction.

Other aspects of the embodiments described herein will be apparent from the following description and the appended claims.

### BRIEF DESCRIPTION OF DRAWINGS

Certain embodiments described herein will be described with reference to the accompanying drawings. However, the accompanying drawings illustrate only certain aspects or implementations of the embodiments by way of example and are not meant to limit the scope of the claims.

FIG. 1 shows a model efficiency optimizer in accordance with one or more embodiments described herein.

FIG. 2 shows an example selective state space model in accordance with one or more embodiments described herein.

FIGS. 3A-3C show a flowchart outlining a method for enhancing selective state space model efficiency through conformal prediction driven adaptive parallelism in accordance with one or more embodiments described herein.

FIG. 4 shows a computing system in accordance with one or more embodiments described herein.

### DETAILED DESCRIPTION

Specific embodiments will now be described with reference to the accompanying figures.

In the below description, numerous details are set forth as examples of embodiments described herein. It will be understood by those skilled in the art (who also have the benefit of this Detailed Description) that one or more embodiments of embodiments described herein may be practiced without these specific details, and that numerous variations or modifications may be possible without departing from the scope of the embodiments described herein. Certain details known to those of ordinary skill in the art may be omitted to avoid obscuring the description.

In the below description of the figures, any component described with regard to a figure, in various embodiments described herein, may be equivalent to one or more like-named components described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to a conformal prediction driven adaptive parallelism controller for enhanced selective state space model efficiency. Particularly, Selective State Space Models (SSMs) are pivotal in the realm of artificial intelligence and machine learning for handling sequential data, yet they encounter significant challenges, particularly in computational efficiency and predictive reliability. These challenges are more pronounced when dealing with large-scale datasets or highly complex sequences, typical in fields like finance, healthcare, natural language processing, and more.

Embodiments described herein address these challenges by integrating conformal prediction with an adaptive parallelism controller in the realm of SSMs. More specifically, the proposed solution dynamically adjusts parallelism strategies (model, data, pipeline) based on real-time data analysis. It utilizes conformal prediction techniques to determine the uncertainty levels of different sequence segments and allocates resources accordingly. This leads to more efficient processing of sequences, particularly those with varying complexities, thereby enhancing the overall computational efficiency of SSMs. Further, the proposed solution allocates computational resources, focusing on segments of the sequence where higher computational power is needed due to increased uncertainty or complexity. This targeted allocation of resources ensures optimal use of computational power, reducing unnecessary expenditure and improving model performance. Moreover, the proposed solution provides a measure of uncertainty for each prediction, offering prediction intervals with a guaranteed probability of containing the true outcome. This addition significantly enhances the reliability of the predictions made by SSMs, which is crucial for informed decision-making in various applications.

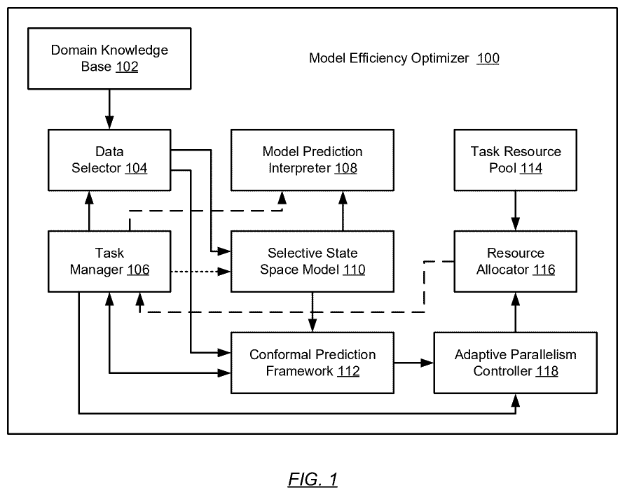

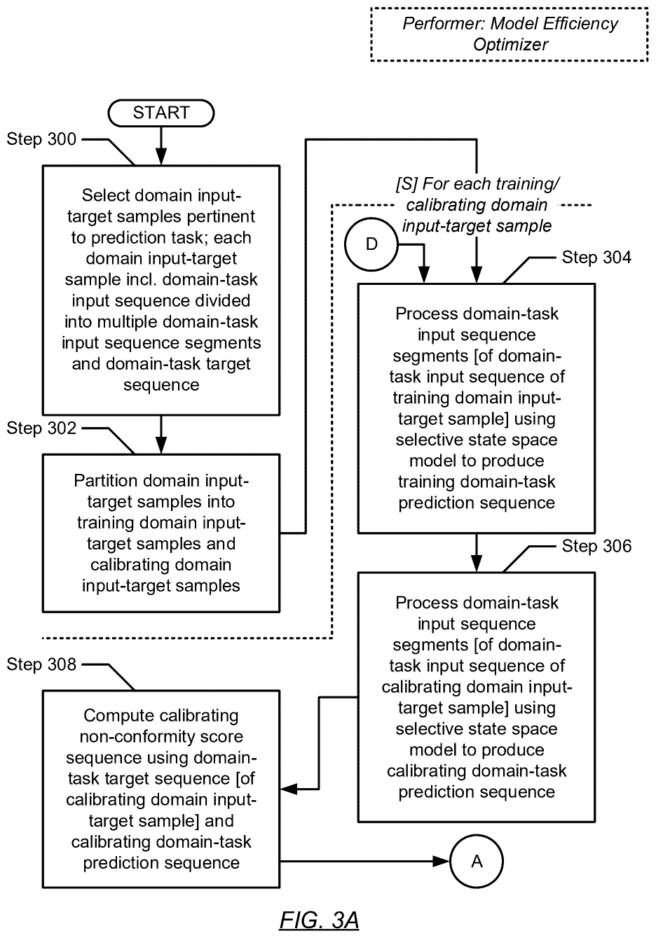

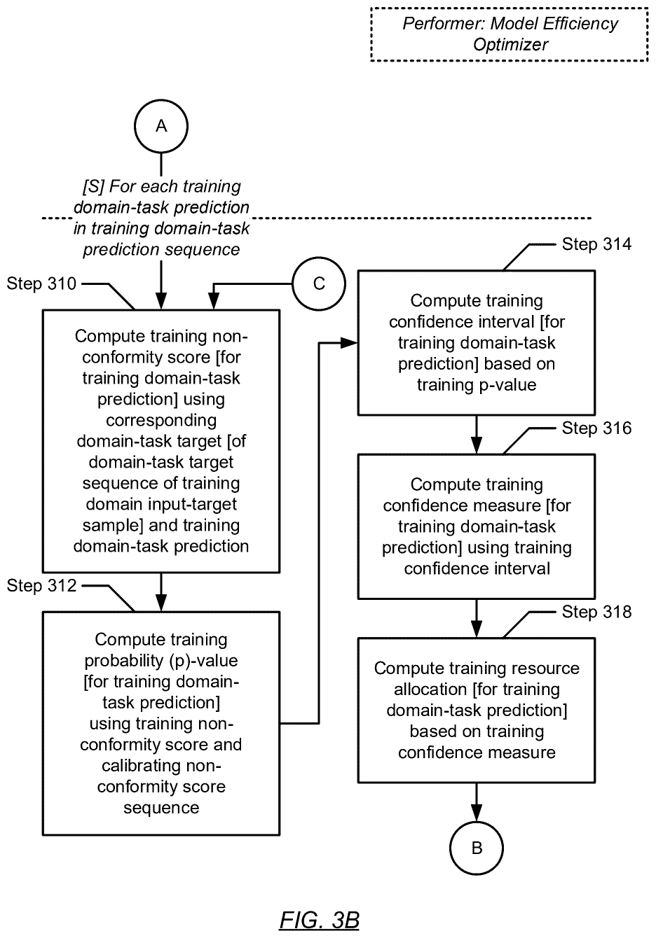

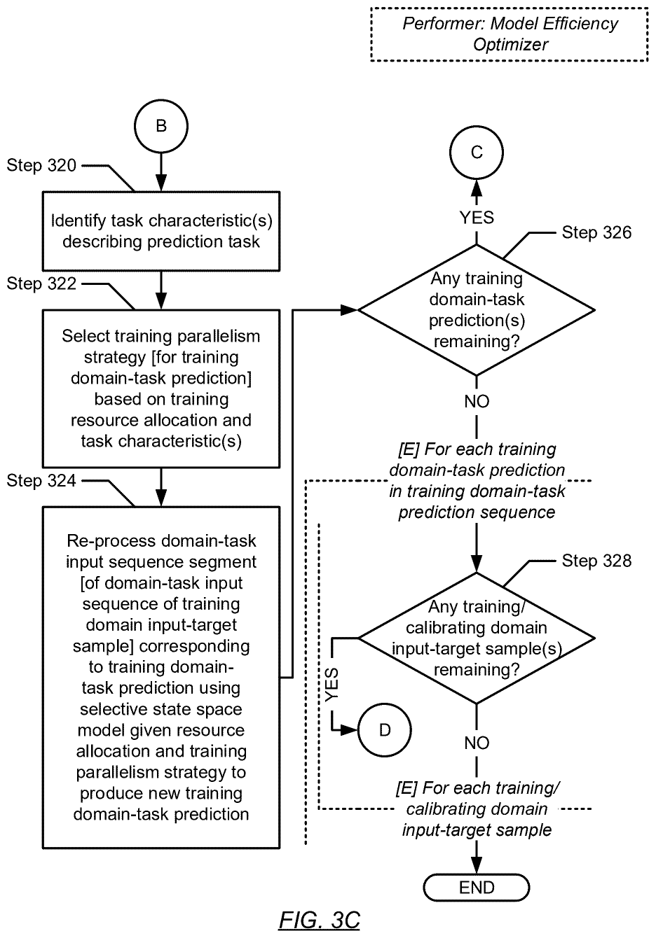

FIG. 1 shows a model efficiency optimizer in accordance with one or more embodiments described herein. The model efficiency optimizer (100) represents enterprise information technology (IT) infrastructure configured for selective state space model efficiency enhancement through conformal prediction driven adaptive parallelism. To said extent, the model efficiency optimizer (100) includes functionality to perform the method outlined and described below with respect to FIGS. 3A-3C. One of ordinary skill, however, will appreciate that the model efficiency optimizer (100) may perform other functionalities without departing from the scope of the embodiments described herein.

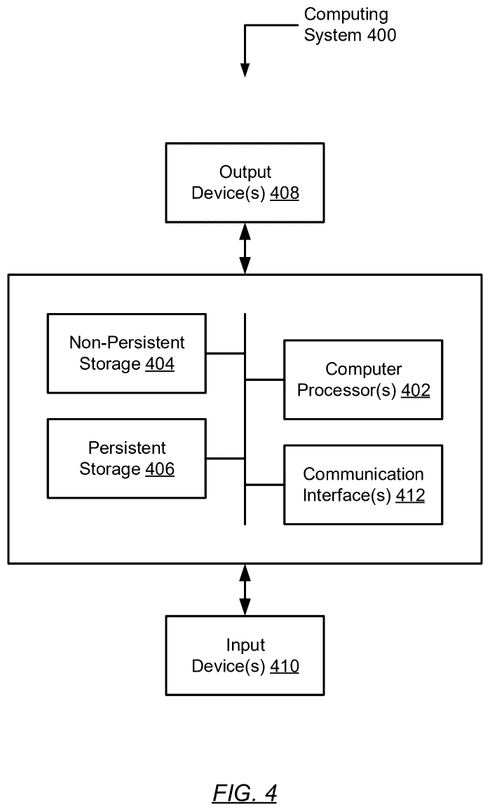

In one or many embodiment(s) described herein, the model efficiency optimizer (100) may be implemented through on-premises infrastructure, cloud computing infrastructure, or any hybrid infrastructure thereof. Accordingly, the model efficiency optimizer (100) may be implemented using one or more network servers (not shown), where each network server represents a physical or a virtual network server. Additionally, or alternatively, the model efficiency optimizer (100) may be implemented using one or more computing devices similar to the exemplary computing system illustrated and described with respect to FIG. 4, below.

In one or many embodiment(s) described herein, the model efficiency optimizer (100) includes a domain knowledge base (102), a data selector (104), a task manager (106), a model prediction interpreter (108), a selective state space model (110), a conformal prediction framework (112), a task resource pool (114), a resource allocator (116), and an adaptive parallelism controller (118). Each of these model efficiency optimizer (100) components is described below.

In one or many embodiment(s) described herein, the domain knowledge base (102) represents a data repository configured to store any information subject to a knowledge domain. Said knowledge domain references a specific field, discipline, or industry. Examples of said knowledge domain include, but are not limited to: product manufacturing, healthcare, banking, agriculture, travel, insurance, engineering, languages, and sports. Further, said any information may include various data, collected from various sources (e.g., sensors, logs, files, external databases, etc.) and of various forms (e.g., sequences/time-series, text, images, videos, audio, etc.), pertinent to one or more prediction tasks relevant to said knowledge domain. A prediction task, in turn, refers to a purpose or objective entailing the estimation of one or more unknown/future values based on known/historical values. By way of a non-limiting example, a prediction task, in the knowledge domain of product manufacturing, may pertain to proactive product maintenance so as to schedule prospective maintenances on one or more products in order to forestall failures and other issues.

In one or many embodiment(s) described herein, the domain knowledge base (102) may be implemented using one or more storage servers (not shown) each including one or more physical storage devices (not shown) on which various forms of information may be maintained. Each physical storage device may encompass non-transitory computer readable storage media on which said digital information may be stored in whole or in part, and temporarily or permanently. Further, the physical storage device(s) may, at least in part, be implement using persistent (i.e., non-volatile) storage. Examples of persistent storage may include, but may not be limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) described herein, the data selector (104) represents instruction-processing hardware (e.g., any number of integrated circuits for processing computer readable instructions), a computer program executing on the underlying hardware of the model efficiency optimizer (100), or a combination thereof, configured for data selection and preparation pertinent to the optimization of the selective state space model (110) efficiency, as well as to the implementation of a given prediction task relevant to a given knowledge domain.

To said extent, the data selector (104) includes functionality to: identify and retrieve raw (unprocessed) data from the domain knowledge base (102), where said raw data may be relevant to the given prediction task; prepare said raw data through one or more of the following processes—cleaning (e.g., removal of anomalies, correction of missing data points, etc.), segmentation (e.g., division of raw data into multiple data segments based on the available task resource pool (114)), transformation (e.g., apply a Fourier transform to analyze said raw data in the frequency domain if appropriate), and time-stamping (to maintain sequential integrity of said raw data)—in order to obtain multiple domain-task input sequences each divvied into a same cardinality of domain-task input sequence segments; create, or prompt a user for, multiple domain-task target sequences that would correspond, respectively, to said multiple domain-task input sequences, where each domain-task target sequence may include domain-task targets of the same cardinality as said domain-task input sequence segments of a corresponding domain-task input sequence; form multiple domain input-target samples each encompassing a domain-task input sequence and a corresponding domain-task target sequence; partition said multiple domain input-target samples into a specified ratio of training domain input-target samples and calibrating domain input-target samples; and provide said training domain input-target samples to the selective state space model (110), as well as provide said calibrating domain input-target samples to the conformal prediction framework (112). One of ordinary skill, however, will appreciate that the data selector (104) may perform other functionalities without departing from the scope of the embodiments described herein.

In one or many embodiment(s) described herein, the task manager (106) represents instruction-processing hardware (e.g., any number of integrated circuits for processing computer readable instructions), a computer program executing on the underlying hardware of the model efficiency optimizer (100), or a combination thereof, configured for orchestration of model efficiency optimizer (100) operations.

To said extent, the task manager (106) includes functionality to: receive prediction tasks from any user(s) of the model efficiency optimizer (100); invoke or instruct the data selector (104) to identify and prepare any data, stored in the domain knowledge base (102) and relevant to said prediction task(s), to serve as training samples for the selective state space model (110) and calibrating samples for the conformal prediction framework (112); obtain training resource allocations, from the resource allocator (116), pertaining to the assignment of at least a subset of the accelerated compute resources of the task resource pool (114) towards the re-processing of said training samples by the selective state space model (110); provide said training resource allocations to the selective state space model (110) to proceed with its re-processing of said training samples; obtain feedback, from the conformal prediction framework (112), in the form of its output (e.g., training confidence measures) for predictions produced by the selective state space model (110); and use said feedback to improve the efficiency and/or accuracy of at least the selective state space model (110), the conformal prediction framework (112), the adaptive parallelism controller (118), and the model prediction interpreter (108) over time. One of ordinary skill, however, will appreciate that the task manager (106) may perform other functionalities without departing from the scope of the embodiments described herein.

In one or many embodiment(s) described herein, the model prediction interpreter (108) represents instruction-processing hardware (e.g., any number of integrated circuits for processing computer readable instructions), a computer program executing on the underlying hardware of the model efficiency optimizer (100), or a combination thereof, configured for recommendation and/or action generation based on refined selective state space model (110) predictions.

To said extent, the model prediction interpreter (108) includes functionality to: obtain refined selective state space model (110) predictions relevant to a prediction task; and provide specific, actionable insights based on an interpretation of said predictions. In continuance of the above-mentioned non-limiting example, where the task prediction is directed to proactive product maintenance in the knowledge domain of product manufacturing, the actionable insights, produced by the model prediction interpreter (108), may include the identification of which product components are likely to fail and the suggestion of optimal times for maintenance in order to forestall said failures. One of ordinary skill, further, will appreciate that the model prediction interpreter (108) may perform other functionalities without departing from the scope of the embodiments described herein.

In one or many embodiment(s) described herein, the selective state space model (110) represents instruction-processing hardware (e.g., any number of integrated circuits for processing computer readable instructions), a computer program executing on the underlying hardware of the model efficiency optimizer (100), or a combination thereof, configured for model prediction generation given training or calibrating inputs.

To said extent, the selective state space model (110) includes functionality to: obtain training domain input-target samples from the data selector (104); for each training domain input-target sample, process domain-task input sequence segments therein to produce a training domain-task prediction sequence; for each training domain input-target sample, provide a domain-task target sequence therein and said produced training domain-task prediction sequence to the conformal prediction framework (112) for uncertainty processing; obtain calibrating domain input-target samples from the data selector (104); for each calibrating domain input-target sample, process domain-task input sequence segments therein to produce a calibrating domain-task prediction sequence; for each calibrating domain input-target sample, provide a domain-task target sequence therein and said produced calibrating domain-task prediction sequence to the conformal prediction framework (112) for uncertainty processing; be configured, by the task manager (106), with training resource allocations (e.g., any subset or all of the accelerated compute resources of the task resource pool (114)); for each training domain input-target sample, re-process said domain-task input sequence segments therein, and in accordance with said configured training resource allocations, to produce a new (or refined) training domain-task prediction sequence; and, for each training domain input-target sample, provide said new/refined training domain-task prediction sequence to the model prediction interpreter (108) for actionable insight generation. One of ordinary skill, however, will appreciate that the selective state space model (110) may perform other functionalities without departing from the scope of the embodiments described herein.

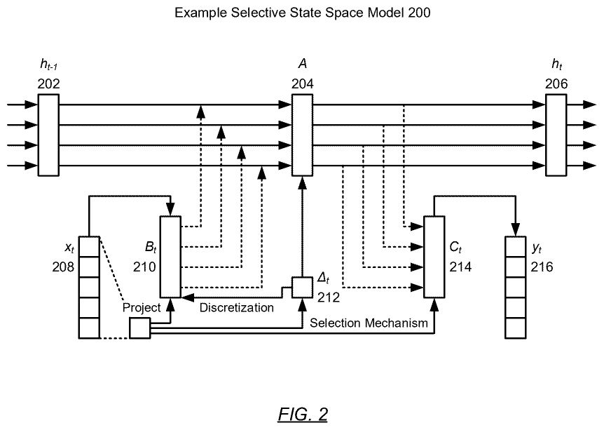

A generalization of the selective state space model (110) is illustrated and described in further detail with respect to FIG. 2, below.

In one or many embodiment(s) described herein, the conformal prediction framework (112) represents instruction-processing hardware (e.g., any number of integrated circuits for processing computer readable instructions), a computer program executing on the underlying hardware of the model efficiency optimizer (100), or a combination thereof, configured for the assessment of uncertainties reflected in model predictions.

To said extent, the conformal prediction framework (112) includes functionality to: obtain a set of domain-task target sequences and calibrating domain-task prediction sequences from the selective state space model (110); compute calibrating non-conformity score sequences based on said set of domain-task target sequences and said calibrating domain-task prediction sequences, respectively; obtain a second set of domain-task target sequences and training domain-task prediction sequences from the selective state space model (110); based on said calibrating non-conformity score sequences, said second set of domain-task prediction sequences, and said training domain-task prediction sequences, compute training non-conformity scores, training probability (p)-values, training confidence intervals, and training confidence measures; and provide said training confidence measures to the resource allocator (116) for further processing. One of ordinary skill, however, will appreciate that the conformal prediction framework (112) may perform other functionalities without departing from the scope of the embodiments described herein.

In one or many embodiment(s) described herein, the task resource pool (114) represents disaggregated accelerated compute resources that form a logical pool thereof. Said task resource pool (114) may be implemented through the connection or combination of multiple physical accelerated compute devices (not shown) over a network fabric. Further, any granularity of the task resource pool (114) may be dynamically provisioned/allocated and de-provisioned/de-allocated to support processing performed by the selective state space model (110). Each physical accelerated compute device, moreover, refers to specialized hardware configured to speed up demanding workloads through the use of parallel processing. Examples of said specialized hardware include, but are not limited to: graphics processing units (GPUs), data processing units (DPUs), tensor processing units (TPUs), vision processing units (VPU), or any combination thereof.

In one or many embodiment(s) described herein, the resource allocator (116) represents instruction-processing hardware (e.g., any number of integrated circuits for processing computer readable instructions), a computer program executing on the underlying hardware of the model efficiency optimizer (100), or a combination thereof, configured for the allocation of accelerated compute resources from the task resource pool (114).

To said extent, the resource allocator (116) includes functionality to: obtain training confidence measures from the conformal prediction framework (112); compute training resource allocations based on said training confidence measures; and provide said training resource allocations to the task manager (106) and the adaptive parallelism controller (118). One of ordinary skill, however, will appreciate that the resource allocator (116) may perform other functionalities without departing from the scope of the embodiments described herein.

In one or many embodiment(s) described herein, the adaptive parallelism controller (118) represents instruction-processing hardware (e.g., any number of integrated circuits for processing computer readable instructions), a computer program executing on the underlying hardware of the model efficiency optimizer (100), or a combination thereof, configured for selection of parallelism strategies to facilitate refined model prediction generation.

To said extent, the adaptive parallelism controller (118) includes functionality to: identify one or more task characteristics describing a prediction task and/or an architecture/structure of the selective state space model (110); obtain training resource allocations from the resource allocator (116); select training parallelism strategies based on the training resource allocations and the task characteristic(s); and provide said training parallelism strategies to the task manager (106) for execution thereof. One of ordinary skill, however, will appreciate that the adaptive parallelism controller (118) may perform other functionalities without departing from the scope of the embodiments described herein.

In one or many embodiment(s) described herein, any subset or all of the above-mentioned model efficiency optimizer (100) components may communicate with one another through a network (not shown) (e.g., a local area network (LAN), a wide area network (WAN) such as the Internet, a mobile network, any other network type, or any combination thereof). The network may be implemented using any combination of wired and/or wireless connections. Further, the network may encompass various interconnected, network-enabled subcomponents (or systems) (e.g., switches, routers, gateways, etc.) that may facilitate communications between said any subset or all of the above-mentioned model efficiency optimizer (100) components. Moreover, in communicating with one another, said any subset or all of the above-mentioned model efficiency optimizer (100) components may employ any combination of wired and/or wireless communication protocols.

While FIG. 1 shows a configuration of components and/or subcomponents, other model efficiency optimizer (100) configurations may be used without departing from the scope of the embodiments described herein.

FIG. 2 shows an example selective state space model in accordance with one or more embodiments described herein. Any selective state space model (SSM) (200) refers to an advanced class of machine learning model primarily used for sequence modeling. Any SSM (200) represents a significant development in the field, combining aspects of recurrent neural networks (RNNs) and convolutional neural networks (CNNs) to process sequential data more effectively. Any SSM (200) is particularly adept at handling long-range dependencies in sequences, making them suitable for a wide range of applications, from natural language processing to time-series analysis.

Furthermore, any SSM (200) leverages state space methods, which involve mapping inputs through a latent state space to predict outputs. This approach allows any SSM (200) to model dynamic systems and sequences with high efficiency. Any SSM (200), accordingly, is designed to capture temporal dynamics and dependencies within data sequences, which is crucial for accurately modeling time-series data or sequences.

In any SSM (200), the idea of selectivity is introduced to allow the model to dynamically focus on different parts of the state space. This can be represented by introducing a selection mechanism in the state transition.

In one or many embodiment(s) described herein, the example selective state space model (200) may be defined by the following parameters:
(a) A previous hidden state vector (hₜ₋₁) (202);
(b) A state transition matrix (A) (204);
(c) An updated hidden state vector (hₜ) (206);
(d) An input vector (xₜ) (208);
(e) An input/control matrix (Bₜ) (210);
(f) A change in the state from hₜ₋₁ to hₜ (Δt) (212);
(g) An observation matrix (Cₜ) (214); and
(h) An output vector (yₜ) (216).

SSMs (200) are well-known predictive models and, therefore, further details entailing their functionality will not be discussed herein.

FIGS. 3A-3C show a flowchart outlining a method for enhancing selective state space model efficiency through conformal prediction driven adaptive parallelism in accordance with one or more embodiments described herein. The various steps outlined below may be performed by the model efficiency optimizer (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 3A, in Step 300, domain input-target samples are selected from the domain knowledge base (see e.g., FIG. 1). In one or many embodiment(s) described herein, any domain input-target sample includes a domain-task input sequence and a domain-task target sequence. Said domain-task input sequence encompasses an ordered list or series of tokens (e.g., numerical values, text units, etc.) representing data relevant to a given prediction task and subject to a given knowledge domain. By way of a non-limiting example, the given prediction task may be directed to network server maintenance, the given knowledge domain may pertain to product manufacturing, and the domain-task input sequence may reflect temperature sensor values over time extracted from a given network server. Said domain-task input sequence, furthermore, may be divided into multiple, non-overlapping domain-task input sequence segments of equal length.

Said domain-task target sequence, meanwhile, encompasses an ordered list or series of domain-task targets (expressed as tokens e.g., numerical values, categorical values, etc.), where each domain-task target corresponds to a given domain-task input sequence segment and represents a correct or true output relevant to the given prediction task and subject to the given knowledge domain. Continuing with the aforementioned non-limiting example, any domain-task target may reflect a numerical value indicating an empirical/observed recommendation strength for performing maintenance on the given network server.

In Step 302, the domain input-target samples (selected in Step 300) are partitioned. Specifically, in one or many embodiment(s) described herein, said domain input-target samples may be partitioned into training domain input-target samples and calibrating domain input-target samples. The former may be used to train a selective state space model (see e.g., FIGS. 1 & 2), whereas the latter may be used to calibrate a conformal prediction framework (see e.g., FIG. 1). Further, partitioning of said domain input-target samples may be such that a training domain input-target samples to a calibrating domain input-target samples ratio equals or exceeds (≥) two to one (2:1).

Hereinafter, a subset of the remaining steps (i.e., Steps 304, 306, 308, 310, 312, 314, 316, 318, 320, 322, 324, 326, and 328) is performed, iteratively as a whole, for each training and/or calibrating domain input-target sample (obtained in Step 302). For example, a first iteration of the indicated remaining steps may be performed with respect to a first training/calibrating domain input-target sample; thereafter, a second iteration of the indicated remaining steps may be performed with respect to a second training/calibrating domain input-target sample; and so forth, including a last iteration of the indicated remaining steps that may be performed with respect to a last training/calibrating domain input-target sample.

In Step 304, the domain-task input sequence segments, of the domain-task input sequence of the training domain input-target sample, are processed using the selective state space model (see e.g., FIGS. 1 & 2). In one or many embodiment(s) described herein, said processing may occur in parallel using multiple accelerated compute resources (see e.g., 114, FIG. 1). Further, through said processing, a training domain-task prediction sequence is produced. Said training domain-task prediction sequence encompasses an ordered list or series of training domain-task predictions (expressed as tokens—e.g., numerical values, categorical values, etc.), where each training domain-task prediction corresponds to a given domain-task input sequence segment and represents an estimated output relevant to the given prediction task and subject to the given knowledge domain. Continuing with the aforementioned non-limiting example, any training domain-task prediction may reflect a numerical value indicating an approximate recommendation strength for performing maintenance on the given network server.

In Step 306, the domain-task input sequence segments, of the domain-task input sequence of the calibrating domain input-target sample, are processed using the selective state space model. In one or many embodiment(s) described herein, said processing may occur in parallel using multiple accelerated compute resources (see e.g., 114, FIG. 1). Further, through said processing, a calibrating domain-task prediction sequence is produced. Said calibrating domain-task prediction sequence encompasses an ordered list or series of calibrating domain-task predictions (expressed as tokens—e.g., numerical values, categorical values, etc.), where each calibrating domain-task prediction corresponds to a given domain-task input sequence segment and represents an estimated output relevant to the given prediction task and subject to the given knowledge domain. Continuing with the aforementioned non-limiting example, any calibrating domain-task prediction may reflect a numerical value indicating an approximate recommendation strength for performing maintenance on the given network server.

In Step 308, a calibrating non-conformity score sequence is computed. In one or many embodiment(s) described herein, computation of said calibrating non-conformity score sequence (αc) may entail taking an absolute value of an element-wise difference between the domain-task target sequence (yc), of the calibrating domain input target sample, and the calibrating domain-task prediction sequence ((xc)) (produced in Step 306): αc=|yc-f(xc)|, or αcₙ=|ycₙ-f(xcₙ)| where nϵN=length of or number of data points in yc=length of or number of data points in f(xc), and f() refers to the predictive model employed (i.e., selective state space model).

Accordingly, in one or many embodiment(s) described herein, said calibrating non-conformity score sequence encompasses an ordered list or series of calibrating non-conformity scores (expressed as numerical values). Each calibrating non-conformity score corresponds to a given calibrating domain-task prediction, and measures how unusual/atypical the calibrating domain-task prediction may be against the corresponding element-wise domain-task target.

Hereinafter, a subset of the remaining steps (i.e., Steps 310, 312, 314, 316, 318, 320, 322, 324, and 326) is performed, iteratively as a whole, for each training domain-task prediction of the training domain-task prediction sequence (produced in Step 304). For example, a first iteration of the indicated remaining steps may be performed with respect to a first training domain-task prediction; thereafter, a second iteration of the indicated remaining steps may be performed with respect to a second training domain-task prediction; and so forth, including a last iteration of the indicated remaining steps that may be performed with respect to a last training domain-task prediction.

Turning to FIG. 3B, in Step 310, a training non-conformity score, for the training domain-task prediction, is computed. In one or many embodiment(s) described herein, computation of said training non-conformity score (αtm) may entail taking an absolute value of a difference between a domain-task target (ytₘ), of the domain-task target sequence (yt) of the training domain input-target sample and corresponding element-wise to the training domain-task prediction, and the training domain-task prediction (f(xtₘ)): αtₘ=|ytₘ-f(xtₘ)| where mϵM=length of or number of data points in yt=length of or number of data points in training domain-task prediction sequence (f(xt)), and f() refers to the predictive model employed (i.e., selective state space model).

Accordingly, in one or many embodiment(s) described herein, said training non-conformity score encompasses a numerical value measuring how unusual/atypical the training domain-task prediction may be against the corresponding element-wise domain-task target.

In Step 312, a training probability (p)-value, for the training domain-task prediction, is computed. In one or many embodiment(s) described herein, computation of said training p-value (ptₘ) may entail a division of an absolute value of a count of instances (or data points) (nϵN) in the calibrating non-conformity score sequence (αc) with a calibrating non-conformity score (αcₙ) greater than or equal to the training non-conformity score (αtₘ) (computed in Step 310) by N=length of or number of data points in αc: ptₘ=|{αcₙ: αcₙ≥αtₘ}|/ N.

Accordingly, in one or many embodiment(s) described herein, said training p-value encompasses a numerical value measuring a probability that the calibrating non-conformity score sequence equals or exceeds the training non-conformity score.

In Step 314, a training confidence interval, for the training domain-task prediction, is computed. In one or many embodiment(s) described herein, computation of said training confidence interval ([CI_{L}, CI_{U}]), including a training confidence interval lower bound (CI_{L}) and a training confidence interval upper bound (CI_{U}), may entail the application of some function (f_{TCI}()) to the training p-value (ptₘ) (computed in Step 312): [CI_{L}, CI_{U}]=f_{TCI}(ptₘ), where the specifics of said some function would depend on a confidence level (e.g., 95%) desired to be achieved and the conformal prediction framework employed.

Said training confidence interval, furthermore, may reflect a level of certainty or reliability in the training domain-task prediction. That is, at least generally, narrow confidence intervals tend to indicate high confidence (or low uncertainty), whereas wide confidence intervals conversely tend to indicate low confidence (or high uncertainty).

In Step 316, a training confidence measure, for the training domain-task prediction, is computed. In one or many embodiment(s) described herein, computation of said training confidence measure (C_{T}) may entail the application of some function (f_{TCM}()) to the training confidence interval [CI_{L}, CI_{U}] (computed in Step 314) that inversely relates to a width (CI_{U}-CI_{L}) thereof: C_{T}=f_{TCM}([CI_{L}, CI_{U}])≈1/(CI_{U}-CI_{L}). With said inverse relationship, a wider training confidence interval results in a lower training confidence measure, while a narrower training confidence interval results in a higher training confidence measure, directed to the training domain-task prediction.

In Step 318, a training resource allocation, for the training domain-task prediction, is computed. In one or many embodiment(s) described herein, computation of said training resource allocation (R_{T}) may entail a product of a scaling factor (k) and a difference between one (1) and the training confidence measure (C_{T}) (computed in Step 316): R_{T}=k×(1-C_{T}). Through the aforementioned expression, high resources would be allocated to predictions with lower confidence, while low resources would conversely be allocated to predictions with high confidence. The allocation of higher resources may reflect a need for deeper analyses of more uncertain predictions, whereas the allocation of lower resources may reflect less uncertain predictions are already quite reliable and further analyses are moot.

Turning to FIG. 3C, in Step 320, one or more task characteristics is/are identified. In one or many embodiment(s) described herein, said task characteristic(s) may each describe the prediction task. Examples of a task characteristic include, but are not limited to: a length or size of domain-task input sequence segments of the domain-task input sequence of the training domain input-target sample; a complexity of the predictive model (e.g., selective state space model); varied levels of uncertainty across training domain-task predictions; and an exhibition of sequential dependencies by said predictive model.

In Step 322, a training parallelism strategy, for the training domain-task prediction, is selected based on the training resource allocation (computed in Step 318) and the task characteristic(s) (identified in Step 320). In one or many embodiment(s) described herein, said training parallelism strategy references a method of distributing computation to multiple workers, or accelerated compute resources. Examples of said training parallelism strategy includes: data parallelism, model parallelism, and pipeline parallelism.

Data parallelism refers to the slicing of large datasets into smaller data subsets that are then distributed to multiple workers, respectively. Data parallelism, further, would be selected as the training parallelism strategy should: (a) the length/size of the domain-task input sequence segments (and/or the domain-task input sequences) reveal to be so large that said domain-task input sequences (and/or the domain-task input sequence segments thereof), in entirety, as well as any corresponding training domain-task predictions, could not be stored in the memory of a single worker; and/or (b) the training domain-task prediction sequence, resulting from the processing of the domain-task input sequence segments (and/or the domain-task input sequences), reflects varied levels of uncertainty there-throughout.

Model parallelism refers to the slicing of tensor (e.g., vector to vector, matrix to matrix, vector to matrix, etc.) operations into chunks that are then distributed to multiple workers, respectively. Model parallelism, further, would be selected as the training parallelism strategy should certain complex aspects of the predictive model (i.e., selective state space model) exhibit high uncertainty in any training domain-task prediction(s) related thereto.

Pipeline parallelism refers to the slicing of a predictive model into multiple predictive model stages that are then distributed to multiple workers, respectively. Pipeline parallelism, further, would be selected as the training parallelism strategy should: (a) the predictive model (i.e. selective state space model) exhibit sequential dependencies; and/or (b) the predictive model include varying levels of complexity across the structure thereof.

In Step 324, a domain-task input sequence segment, of the domain-task input sequence of the training domain input-target sample, is re-processed. In one or many embodiment(s) described herein, said domain-task input sequence segment may correspond to the training domain-task prediction. Further, said re-processing may entail processing of the domain-task input sequence segment using the selective state space model (see e.g., FIGS. 1 & 2) and given the training resource allocation (computed in Step 318) as well as the training parallelism strategy (selected in Step 322). Said re-processing, moreover, may subject the domain-task input sequence segment to an optimized analysis thereof based on the ascertained uncertainty of the corresponding training domain-task prediction. Through said optimized analysis, a new (more refined) training domain-task prediction may be produced, wherein interpretations thereof may subsequently lead to more reliable recommendations or actions relevant to the prediction task.

In Step 326, a determination is made as to whether any training domain-task prediction(s), of the training domain-task prediction sequence (produced in Step 304), remain(s) such that a corresponding new training domain-task prediction may be produced. In one or many embodiment(s) described herein, if it is determined that zero training domain-task predictions remain, then the method proceeds to Step 328. On the other hand, in one or many other embodiment(s) described herein, if it is alternatively determined that at least one training domain-task prediction remains, then the method alternatively proceeds (back) to Step 310, where a training non-conformity score is computed for a next training domain-task prediction.

In Step 328, a determination is made as to whether any training and/or calibrating domain input-target sample(s) (obtained in Step 302) remain(s) to be processed. In one or many embodiment(s) described herein, if it is determined that zero training/calibrating domain input-target samples remain, then the method ends. On the other hand, in one or many other embodiment(s) described herein, if it is alternatively determined that at least one training/calibrating domain input-target sample remains, then the method proceeds (back) to Step 304, where domain-task input sequence segments, pertaining to the domain-task input sequence of a next training domain input-target sample, undergoes processing.

FIG. 4 shows a computing system in accordance with one or more embodiments described herein. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one or many embodiment(s) described herein, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one or many embodiment(s) described herein, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments described herein.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for prediction refinement, the method comprising:
for each training domain-task prediction in a training domain-task prediction sequence:
computing a training non-conformity score based on a domain-task target and the training domain-task prediction;
computing a training probability (p)-value based on the training non-conformity score and a calibrating non-conformity score sequence;
computing a training confidence interval based on the training p-value;
computing a training confidence measure based on the training confidence interval;
computing a training resource allocation based on the training confidence measure;
selecting a training parallelism strategy based on the training resource allocation and at least one task characteristic; and
processing, given the training resource allocation and in accordance with the training parallelism strategy, a domain-task input sequence segment to produce a refined training domain-task prediction.

2. The method of claim 1, wherein the training confidence measure reflects an uncertainty associated with the training domain-task prediction.

3. The method of claim 1, wherein the training resource allocation comprises multiple accelerated compute resources.

4. The method of claim 1, wherein the training parallelism strategy is one selected from a parallelism group comprising data parallelism, model parallelism, and pipeline parallelism.

5. The method of claim 1, wherein the at least one task characteristic is relevant to a prediction task, and describes at least one of the domain-task input sequence segment and a predictive model that produced the training domain-task prediction.

6. The method of claim 5, wherein the predictive model is a selective state space model.

7. The method of claim 6, the method further comprising:
prior to computing the training non-conformity score for each training domain-task prediction:
processing, of a training domain input-target sample, domain-task input sequence segments using the selective state space model to produce the training domain-task prediction sequence,
the domain-task input sequence segments comprising the domain-task input sequence segment;
processing, of a calibrating domain input-target sample, second domain-task input sequence segments using the selective state space model to produce a calibrating domain-task prediction sequence; and
computing the calibrating non-conformity score sequence based on a task domain target sequence, of the calibrating domain input-target sample, and the calibrating domain-task prediction sequence.

8. The method of claim 7, wherein the training domain input-target sample and the calibrating domain input-target sample are pertinent to the prediction task, and are subject to a knowledge domain.

9. A non-transitory computer readable medium (CRM) comprising computer readable program code, which when executed by a computer processor, enables the computer processor to perform a method for prediction refinement, the method comprising:
for each training domain-task prediction in a training domain-task prediction sequence:
computing a training non-conformity score based on a domain-task target and the training domain-task prediction;
computing a training probability (p)-value based on the training non-conformity score and a calibrating non-conformity score sequence;
computing a training confidence interval based on the training p-value;
computing a training confidence measure based on the training confidence interval;
computing a training resource allocation based on the training confidence measure;
selecting a training parallelism strategy based on the training resource allocation and at least one task characteristic; and
processing, given the training resource allocation and in accordance with the training parallelism strategy, a domain-task input sequence segment to produce a refined training domain-task prediction.

10. The non-transitory CRM of claim 9, wherein the training confidence measure reflects an uncertainty associated with the training domain-task prediction.

11. The non-transitory CRM of claim 9, wherein the training resource allocation comprises multiple accelerated compute resources.

12. The non-transitory CRM of claim 9, wherein the training parallelism strategy is one selected from a parallelism group comprising data parallelism, model parallelism, and pipeline parallelism.

13. The non-transitory CRM of claim 9, wherein the at least one task characteristic is relevant to a prediction task, and describes at least one of the domain-task input sequence segment and a predictive model that produced the training domain-task prediction.

14. The non-transitory CRM of claim 13, wherein the predictive model is a selective state space model.

15. The non-transitory CRM of claim 14, the method further comprising:
prior to computing the training non-conformity score for each training domain-task prediction:
processing, of a training domain input-target sample, domain-task input sequence segments using the selective state space model to produce the training domain-task prediction sequence,
the domain-task input sequence segments comprising the domain-task input sequence segment;
processing, of a calibrating domain input-target sample, second domain-task input sequence segments using the selective state space model to produce a calibrating domain-task prediction sequence; and
computing the calibrating non-conformity score sequence based on a task domain target sequence, of the calibrating domain input-target sample, and the calibrating domain-task prediction sequence.

16. The non-transitory CRM of claim 15, wherein the training domain input-target sample and the calibrating domain input-target sample are pertinent to the prediction task, and are subject to a knowledge domain.

17. A model efficiency optimizer, comprising:
a computer processor configured to perform a method for prediction refinement, the method comprising:
for each training domain-task prediction in a training domain-task prediction sequence:
computing a training non-conformity score based on a domain-task target and the training domain-task prediction;
computing a training probability (p)-value based on the training non-conformity score and a calibrating non-conformity score sequence;
computing a training confidence interval based on the training p-value;
computing a training confidence measure based on the training confidence interval;
computing a training resource allocation based on the training confidence measure;
selecting a training parallelism strategy based on the training resource allocation and at least one task characteristic; and
processing, given the training resource allocation and in accordance with the training parallelism strategy, a domain-task input sequence segment to produce a refined training domain-task prediction.

18. The model efficiency optimizer of claim 17, further comprising:
accelerated compute resources operatively connected to the computer processor, wherein the training resource allocation comprises at least a subset of the accelerated compute resources.

19. The model efficiency optimizer of claim 17, further comprising:
a selective state space model configured to execute on the computer processor, wherein the domain-task input sequence segment is processed using the selective state space model.

20. The model efficiency optimizer of claim 17, further comprising:
a conformal prediction framework configured to execute on the computer processor, and to assess an uncertainty of the training domain-task prediction.
